(19) United States
(12) Patent Application Publication
(10) Pub. No.: US 2012/0199705 A1
(43) Pub. Date: Aug. 9, 2012

(54) Item Support Stand For Use Outdoors

(76) Inventor: Theodore Will, Fort Recovery, OH (US)

(21) Appl. No.: 13/022,667

(22) Filed: Feb. 8, 2011

(51) Int. Cl. F16M 11/04

(52) U.S. Cl. 248/121

(57) ABSTRACT

An item support stand comprising a central support bar extending an entire length of the item support stand, where the central support bar includes a main body and a lower portion; an end at the lower portion of the support stand, where the end sticks into a ground to enable the central support bar to stand upright; a top beam attached to a top portion of the central support bar, where the top beam curves down and out to create a support bar at each end; and a retaining member fastened to the top beam wherein the retaining member provides radial support for an item placed within the retaining member and resting upon the support bar.

### BACKGROUND OF THE INVENTION

1. Field of the Invention

The present invention relates to a stand to elevate at least one item above the ground for use outdoors.

2. Description of Related Art

While spending time outdoors, locations to place indoor items may be limited or non-existent. For example, when a person is lounging in a lawn chair or walking through a garden there are no readily available locations for them to place a drink or container. Unless the person wishes to place all of their items on the ground they must either refrain from bringing the objects or provide their own structure for support. Many times a person may simply desire a place to rest their drink container without worrying that it will be knocked to the ground or invaded by bugs. Providing an entire table would be a hassle for such small objects and burdensome for the user to carry.

U.S. Pat. No. 5,570,863 by Cooper discloses a drink holder wherein a drink container supporting structure, primarily for use outdoors, includes a lower portion to insert into the ground and a spiral adapted to the upper end to hold a beverage container. The drink holder supports a single beverage at an elevated position.

U.S. Patent Application No. 2008/0017765 discloses a ground-penetrating beverage holder wherein the holder is a continuous wire that penetrates the ground at a lower end and at an upper end coils to provide a base and a circular support for a beverage container. Two of the beverage holders may be positioned with a central connector to support more than one beverage.

It would be desirable in the art to provide an elevated beverage holder to allow a user to enjoy their beverages outdoors. It would also be beneficial to provide a beverage stand that enables more than one container to be supported.

### SUMMARY OF THE INVENTION

An object of the present invention is to provide a stand for items wherein the stand supports the items at an elevated position above the ground for use outdoors.

Another object of the present invention is to provide a stand for items that supports one to two items at the elevated position.

Another object of the present invention is to provide a stand that is compact and easy to transport.

In view of the foregoing disadvantages inherent in the prior art, the purpose of the present disclosure is to provide an item support stand comprising a central support bar extending an entire length of the item support stand, where the central support bar includes a main body and a lower portion; an end at the lower portion of the support stand, where the end sticks into a ground to enable the central support bar to stand upright; a top beam attached to a top portion of the central support bar, where the top beam curves down and out to create a support bar at each end; and a retaining member fastened to the top beam wherein the retaining member provides radial support for an item placed within the retaining member and resting upon the support bar.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an item support stand in accordance with an exemplary embodiment of the present invention; and

FIG. 2 depicts an enlarged view of an item support stand in accordance with an exemplary embodiment of the present invention.

Like reference numerals refer to like parts throughout the description of several views of the drawings.

### DETAILED DESCRIPTION OF THE DRAWINGS

The present invention relates to a stand to elevate at least one item above the ground for use outdoors. The present invention provides an item support stand as a housing device to hold beverages or plants. The item support stand includes a central bar that stands upright with two support members attached to the top to hold the items. Along the bottom portion is a foot rod to allow a user to depress the central bar into the ground. The item support stand provides a cup holder for use on a lawn, garden or in the sand. The lightweight construction and simple design of the item support stand may appeal to a variety of users because they may pack it with their beach chairs or store it in a corner of their garage. By allowing greater mobility and hands free operation the item support stand provides the users with the peace of mind that their drinks won't spill or invaded by insects.

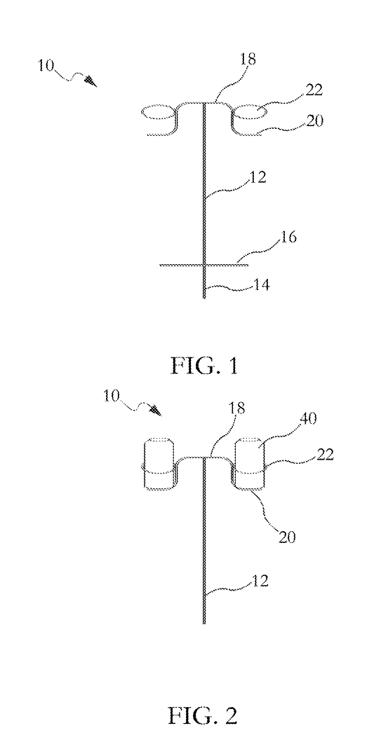

Turning now descriptively to the drawings, referring to FIG. 1, a perspective view of an item support stand (10) is shown in accordance with an exemplary embodiment of the present invention. The item support stand (10) may include a central support bar (12) which encompasses an entire length of the item support stand (10). The central support bar (12) may be comprised of a heavy gauge wire or a molded plastic able to withstand varying temperatures and inclement weather. The central support bar (12) may extend a length ranging from 40-50 inches, with an optimal length of 44 inches. The item support stand (10) is designed to be used outdoors possibly in a garden, on a lawn or in the sand.

At a lower portion of the central support bar (12) is an end (14). Attached perpendicularly to a lower portion of the central support bar (12) may be a base bar (16). The base bar (16) intersects the central support bar (12) to divide a main body of the central support bar (12) from the end (14). The base bar (16) may be soldered, molded or pinned to the central support bar (12). For use, the end (14) presses into the ground and stops at the base bar (16). A user may use the base bar (16) as a foot press to lower the end (14) into the ground. The end (14) may be tapered to a point to better allow the user to penetrate the ground. With the lower end (14) engaged with the ground the item support stand (10) may stand upright balanced by the base bar (16).

Attached perpendicularly to a top portion of the central support bar (12) is a top beam (18). A center of the top beam (18) makes a “T” with the central support bar (12), and then curves down and out to a support bar (20) at each end. The top beam (18) and the support bar (20) create a bell shape with a pair of extended flanges at each end. The top beam (18) and the support bar (20) may be made from the same materials as the central support bar (12) for ease of construction and costs.

Affixed to the top beam (18) at an area where the top beam bends downward is a retaining member (22). The retaining member (22) creates a barrier or a radial support for an item placed within the retaining member (22). The retaining member (22) may be a loop, ring or basket to peripherally contain the item. During use, the user slides the item through the retaining member (22) and allows the item to rest upon the support bar (20). The item may be a bottle, can, cup, glass, planter, candle or similar object. The support bar (20) provides a base upon which the item can rest, while the retaining member (22) provides peripheral support so that the item does not tip or fall.

Now referring to FIG. 2, an enlarged view of the item support stand (10) is shown in accordance with an exemplary embodiment of the present invention. The top beam (18) is shown with a beverage can (40) within each retaining member (22). As illustrated, the item support beam (10) provides a cup holder to enable the user to enjoy a beverage outdoors without risk that the beverage will spill or topple due to an uneven ground. The item support stand (10) elevates the user's drink to a height easily accessible above the ground, especially if they are sitting in a lawn chair, walking through a garden, or playing games in a yard. Additionally, the elevated position prevents bugs crawling on the ground from getting into the user's beverage. The item support stand (10) is small enough to easily transport thereby making it a convenient outdoor accessory.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An item support stand comprising:
a central support bar extending an entire length of said item support stand, where said central support bar includes a main body and a lower portion;
an end at said lower portion of said support stand, where said end sticks into the ground to enable said central support bar to stand upright;
a top beam attached to a top portion of said central support bar, where said top beam curves down and out to create a support bar at each end; and
a retaining member fastened to said top beam wherein said retaining member provides radial support for an item placed within said retaining member and resting upon said support bar.

2. The item support stand according to claim 1, wherein said central support bar includes a base bar that intersects said central support bar to divide said main body from said end.

3. The item support stand according to claim 2, wherein said base bar provides balance for said central support bar to stand upright.

4. The item support stand according to claim 2, wherein said base bar is used as a foot press to a user to press said end into the ground.

5. The item support stand according to claim 1, wherein said end is tapered to penetrate the ground.

6. The item support stand according to claim 1, wherein said items are one of at least a cup, a bottle, a can, a glass, a planter and a candle.

7. The item support stand according to claim 1, wherein said retaining member is one of a ring, a loop and a basket.
